(19) United States
(12) Patent Application Publication
(10) Pub. No.: US 2007/0172687 A1
(43) Pub. Date: Jul. 26, 2007

(54) Method for producing coated substrates

(75) Inventors: Marta Martin-Portugues, Ludwigshafen (DE); Gunter Scherr, Ludwigshafen (DE); Thomas Damian, Erpolzheim (DE); Claus Fueger, Lemberg (DE); Ralph Lunkwitz, Neustadt (DE); Jakob Decher, Bobenheim-Roxheim (DE); Albert Sester, Oberkirch (DE)

Correspondence Address: CONNOLLY BOVE LODGE & HUTZ, LLP, P O BOX 2207, WILMINGTON, DE, 19899, US

(73) Assignee: BASF Aktiengesellschaft, Ludwigshafen (DE)

(21) Appl. No.: 11/596,130

(22) PCT Filed: May 21, 2005
(86) PCT No.: PCT/EP05/05518

§ 371 Date: Nov. 9, 2006

(30) Foreign Application Priority Data
May 27, 2004 (DE) 10 2004 026 481.3
May 27, 2004 (DE) 10 2004 026 480.5

(51) Int. Cl. B32B 27/10

(52) U.S. Cl. 428/531; 264/314; 264/259

(57) ABSTRACT

The present invention relates to a process for the production of laminated substrates having a three-dimensionally structured surface, wherein a decorative paper which comprises from 5 to 90% by weight, based on the total fiber content, of fibers of synthetic polymers is impregnated with a crosslinkable aminoplast resin, applied to the substrate and three-dimensionally shaped. Furthermore, the invention relates to aminoplast resin sheets or films, and the use of a modified decorative paper for the production of aminoplast resin sheets or films for 3D lamination.

The invention relates to a process for the production of laminated substrates. The invention furthermore relates to aminoplast resin sheets or films, and the use of a modified decorative paper for the production of aminoplast resin sheets or films for 3D lamination.

Usually, thermoplastic sheets are used for lamination with three-dimensionally structured surfaces (3D lamination), for example for the lamination of wood-base materials in the furniture industry. The important advantage of these thermoplastic sheets is the resilience thereof, but the high costs of production, due inter alia to the additional use of adhesives, are disadvantageous.

The use of the self-adhesive economical melamine resins, which are used, for example, in the furniture industry for finishing smooth surfaces, is also desirable for the lamination of three-dimensionally structured surfaces. The melamine resins are furthermore distinguished by high gloss and good printability. However, pure melamine resins are too brittle for this application.

Improved flexibility of the sheets could be achieved according to DE-A 23 09 334 by means of etherified melamine resins carrying methylol groups. These melamine resin sheets are used in particular for the surface finishing of wood-base materials, such as hard particle boards and blackboards. In order to achieve the flexibility and resilience required for the lamination of, for example, rounded edges, the melamine resins were further modified, for example by adding guanamine, according to DE-A 44 39 156, or by adding small amounts of an aqueous synthetic resin dispersion, according to DE-A 38 37 965. According to DE-A 37 00 344, a combination of aminoplast resins with acrylate dispersions results in a certain resilience of the sheets produced, but a high proportion of dispersion caused a substantial loss of stretchability and internal bond strength, properties which are necessary precisely in the lamination of three-dimensionally structured surfaces.

The prior German Application with the application number 10301901.4 discloses for the first time self-adhesive melamine resin films which can be used directly for 3D lamination of pieces of furniture. These melamine resins consist of a mixture of melamine/formaldehyde condensates, etherified melamine/formaldehyde condensates and acrylate dispersions. The melamine resin films described are well suited for the lamination of three-dimensionally shaped surfaces.

Improved flexibility of the sheets could furthermore be achieved by modifying the decorative paper to be impregnated with the melamine resin. WO 00/53666, WO 00/53667, WO 00/53668 and WO 02/38345 describe different fiber papers for the lamination of, for example, bodies having three-dimensional structures. WO 00/53666 discloses for this purpose a carrier which consists of meltable polymers and cellulose or regenerated cellulose. Cellulose esters and preferably cellulose acetate are described as meltable polymers. WO 00/53667 describes fiber papers with the use of carriers based completely or partly on regenerated cellulose. The regeneration of the cellulose consists in a conversion into a soluble cellulose derivative with the use of an acid, it being possible to convert the derivative into fibers and, if appropriate, to reduce the size of the fibers. WO 00/53668 describes carriers comprising fibrous cellulose esters, preferably cellulose acetates. WO 02/38345 describes the use of decorative paper which contains at least 10% by weight and up to 100% by weight, based on the total fiber content, of cotton linters for the lamination of three-dimensionally structured surfaces.

In spite of the successes achieved to date, the known sheets or films comprising the modified melamine resins and decorative papers are still worthy of improvement. In particular, there is still a need to optimize the property of resilience of the sheets or of the films. For esthetic reasons and simultaneously for simplifying the production, the lamination should be effected only with a single sheet or film in a single pressing process. The main feature of such sheets or films is the moldability during the pressing process.

It was accordingly the object of the invention to provide an improved process for the production of a laminated substrate having a three-dimensionally structured surface. In particular, it was intended to provide a process for the production of a laminated piece of furniture or wood-base material having a three-dimensionally structured surface. Furthermore, it was intended to provide a more flexible melamine resin sheet or film which is also suitable for the 3D lamination and in particular for the complete surrounding of structures. The laminated surfaces should have no white fracture, i.e. background which gleams through, and undesired creases at the compression points.

A process which is particularly suitable for the production of partly or completely laminated substrates having a three-dimensionally structured surface, in which a decorative paper which comprises from 5 to 90% by weight, based on the total fiber content, of fibers of synthetic polymers is impregnated with a crosslinkable aminoplast resin, applied to a substrate and three-dimensionally shaped, was surprisingly found.

The term “three-dimensional shaping” is to be understood as meaning the partial or complete lamination of bodies, structures, reliefs, profiles, embossings and the like. These have three-dimensionally structured surfaces, i.e. shapes, forms or structures which extend in all three directions in space. The changes in shape can be either continuous or abrupt, such as, for example, in the case of sharp-edged structures, such as edges, corners and/or points, which describe a defined angle which results from two or more planes meeting one another. Furthermore, “three-dimensional shaping” is also to be understood as meaning the complete surrounding or simultaneous lamination of fronts and edges, of regular or irregular moldings, profiles and the like.

Polyamide, polyimide, polyurethanes, polypropylene, polyethylene, polyacrylonitrile, polyvinyl alcohol or various polyesters, for example polyethylene terephthalate, polybutylene terephthalate, polytrimethylene terephthalate or polyethylene naphthalate, are advantageously used as starting material for the fibers of synthetic polymers. The use of fibers of polyamide, polyester, polypropylene or polyethylene is preferred.

Mixtures of fibers of synthetic polymers are likewise advantageous. For example, a mixture of two of the abovementioned synthetic fibers, such as, for example, polyamide, polypropylene, polyethylene and polyester fibers, in a weight ratio of from 1:99 to 99:1, can be used. Depending on the specification of the decorative papers to be obtained, it is possible to choose advantageous fiber mixtures, it also being possible for more than two fiber types to be present.

It is also possible to use fibers of copolymers or polymer blends, for example block polymers or polymer blends of polyamide, polyimide, polyurethanes, polypropylene, polyethylene, polyacrylonitrile, polyvinyl alcohol or various polyesters, for example polyethylene terephthalate, polybutylene terephthalate, polytrimethylene terephthalate or polyethylene naphthalate, being used. Copolymers of monomers such as, for example, propylene, ethylene, (meth)acrylonitrile, vinyl alcohol or esters, for example of vinyl alcohol, may also serve as a basis for the production of the synthetic fibers.

The fibers of synthetic polymers are advantageously branched as little as possible, in particular unbranched. The individual fibers have lengths similar to those of typical natural fibers. Advantageously, the synthetic fibers have a length of from 0.5 to 20 mm, in particular from 0.5 to 10 mm, particularly preferably from 2 to 10 mm. The fiber diameter is as a rule from 5 to 30 μm, preferably from 10 to 25 μm. The fibers furthermore have a mean surface area of from 1500 to 3500 m²/g, in particular from 2000 to 2500 m²/g.

The production of the synthetic fibers is known to a person skilled in the art. Conventional production processes are, for example, the spinning process or production by means of the flashing process.

The synthetic fibers can be mixed in any desired ratio with the pulp fiber of the decorative paper comprising, for example, birch, eucalyptus and long-fiber pulp, such as pine or spruce, and can be processed on all conventional paper machines. Furthermore, other tree species or gas, bush and cereal pulps are also suitable. Further details are to be found in “Fasern für den Papiermacher” from P. Keppler Verlag KG. The pulps are obtainable, for example, by means of the sulfite or of the sulfate production process. The pulps can, if appropriate, be bleached by various methods known to a person skilled in the art. The cellulose fibers are selected according to the field of use, the advantages and disadvantages of the individual cellulose fibers being known to those skilled in the art. The processing of the fibers to give decorative paper is generally known. Depending on the fiber type and fiber content used, slight changes in the papermaking are required, for example in the fiber mixing, fiber pretreatment, fiber addition, beating and process control. During the drying of the decorative paper, the temperature should advantageously not exceed a range from 50 to 150° C. Temperatures above 120° C. can lead to reduced sheet thickness. Furthermore, conventional finishing processes, such as, for example, calendering, adhesion, embossing, printing (for example gravure, flexography, digital printing), impregnation, molding and/or varnishing, can be effected downstream of the generally known decorative papermaking.

The decorative papers used according to the invention have a Bendtsen porosity of from 300 to 2000 ml/min, in particular from 400 to 1200 ml/min, and thus possess very good impregnatability. The porosity is appropriately adapted to the impregnation requirements. The wet strength is advantageously from 6 N to 40 N. The covering power of the decorative paper is as a rule from 0 to 100%, in particular from 60 to 100%. The decorative paper usually has a basis weight of from 40 to 300 g/m², in particular from 80 to 200 g/m². The perceived color is between white and black, and colors in numerous shades can be realized.

The decorative papers may be smooth on one or both sides, smoothness on one side being preferred.

The decorative paper which comprises from 5 to 90% by weight, based on the total fiber content, of fibers of synthetic polymers advantageously comprises from 95 to 10% by weight of cellulose. The cellulose is advantageously chemically unchanged. The cellulose can in principle be used in bleached or unbleached form. The use of bleached cellulose is preferred. Advantageously, eucalyptus globulus, Nordic birch and long fibers are used. The decorative paper preferably comprises from 10 to 60% by weight, based on the total fiber content, of fibers of synthetic polymers and from 90 to 40% by weight of cellulose. In particular, the decorative paper comprises from 10 to 40% by weight, based on the total fiber content, of fibers of synthetic polymers and from 90 to 60% by weight of cellulose. Particularly preferably, the decorative paper contains from 10 to 40% by weight, based on the total fiber content, of fibers of polyamide, polyester, polypropylene and/or polyethylene.

In addition to the cellulose fibers and the fibers of synthetic polymer, the decorative paper used according to the invention may comprise other conventional components known to a person skilled in the art, such as, for example, secondary fibers, fillers or pigments. The inorganic or organic pigments control, inter alia, the opacity production, imparting of color, printability and increase in thickness. Advantageously, white or colored pigments as compounds in the form of oxides, silicates, carbonates, sulfates or carbon blacks may be present in the formulation.

Preferred inorganic pigments which can serve as colorants in the decorative paper used according to the invention are, for example, iron oxides, iron cyanoferrates, sodium aluminum silicates and/or titanium dioxides. The titanium dioxides are prepared, for example, by the chloride or the sulfate process. Depending on the field of use, they may be modified, for example coated. The modification can be effected by means of various materials, for example with phosphorus, phosphorus pentoxide, aluminum, zirconium, alumina and/or silica.

Preferred organic pigments which may serve as colorants in the decorative paper used according to the invention are, for example, those from the class consisting of the monoazo pigments (for example products which are derived from acetoacetyl arylide derivatives or from β-naphthol derivatives), laked monoazo dyes (e.g. laked β-oxynaphthoic acid dyes), disazo pigments, condensed disazo pigments, isoindoline derivatives, derivatives of naphthalene- or perylenetetracarboxylic acid, anthraquinone pigments, thioindigo derivatives, azomethine derivatives, quinacridones, dioxazines, pyrazoloquinazolones, phthalocyanine pigments or laked basic dyes (for example laked triarylmethane dyes).

The total pigment content in the finished base paper is advantageously from 0 to 40% by weight, based on the total paper, in particular from 5 to 20% by weight. With the use of pigments, from 5 to 10% by weight of pigments based on silicates and up to 20% by weight, preferably from 0 to 15% by weight, of titanium dioxides and iron oxides are used.

The decorative papers having high wet strength can as a rule usually be processed again without problems within known standard processes.

Suitable crosslinkable aminoplast resins are all resins known to a person skilled in the art, in particular melamine/urea/formaldehyde and melamine/formaldehyde resin or mixtures thereof. These resins may have been partly or completely etherified with alcohols, preferably C₁- to C₄-alcohols, in particular methanol. Etherified and unetherified melamine/urea/formaldehyde and melamine/formaldehyde resins or mixtures thereof are preferably used, in particular etherified and/or unetherified melamine/formaldehyde resins, particularly preferably unetherified melamine/-formaldehyde resins.

Resin mixtures which comprise unetherified melamine/formaldehyde condensate(s), if appropriate etherified melamine/formaldehyde condensate(s) and polymer dispersion(s) are particularly preferred.

Particularly suitable resin mixtures are those which comprise
(i) from 5 to 90% by weight, in particular from 20 to 80% by weight, of one or more unetherified melamine/formaldehyde condensates,
(ii) from 0 to 80% by weight, in particular from 0 to 50% by weight, of one or more etherified melamine/formaldehyde condensates and
(iii) from 10 to 95% by weight, in particular from 20 to 80% by weight, of one or more polymer dispersions.

The stated amounts of the components (i), (ii) and (iii) sum to 100% by weight and are based on the liquid resin mixture.

Assistants and additives may also be added to the melamine resin mixture, for example from 0.1 to 50% by weight, preferably from 0.2 to 30% by weight, in particular from 0.5 to 20% by weight, of urea, caprolactam, phenoldiglycol, butanediol and/or sucrose, based on 100% by weight of the mixture (i) to (iii). Furthermore, they may comprise conventional additives, such as, for example, wetting agents, curing agents and catalysts.

In addition, the resin mixture may comprise one or more of the following components in a total amount of from 0 to 5% by weight, based on the resin mixture: anionic surfactants (sodium, potassium and/or ammonium salts of fatty acid and sulfonic acid; alkali metal salts of C₁₂- to C₁₆-alkylsulfates; ethoxylated, sulfated and/or sulfonated fatty alcohols; alkylphenols; sulfodicarboxylated esters; polyglycol ether sulfates), nonionic surfactants (ethoxylated fatty alcohols and alkylphenols having 2 to 150 ethylene oxide units per molecule), cationic surfactants (ammonium, phosphonium and/or sulfonium compounds having a hydrophobic structural element which comprises at least one long aliphatic hydrocarbon chain), starch, polyethylene glycol and/or poly(vinyl alcohol).

The following may be stated specifically regarding the resin components: Melamine/formaldehyde condensates are used as resin component (i). The preparation of the resin component (i) is generally known. First, for example, 1 mol of melamine is condensed with from 1.4 to 2 mol of formaldehyde at a pH of from 7 to 9 and at temperatures of from 40 to 100° C., until the suitable degree of condensation is reached. Advantageously, the molar ratio of melamine to formaldehyde is from 1:1.15 to 1:1.9, preferably from 1:1.4 to 1:1.6.

In the resin component (ii), melamine/formaldehyde condensates are etherified with C₁-to C₄-alkanols, such as methanol, ethanol, propanol and/or butanol or glycols, such as, for example, ethylene glycol, diethylene glycol, propylene glycol and/or dipropylene glycol. Methanol and butanol are preferred. The preparation of the resin component (ii) is generally known. For example, from 20 to 30 mol of methanol are added to the melamine/formaldehyde condensate and etherification is effected at a pH of 1 to 5 and temperatures of from 40 to 80° C. The condensation conditions depend on the water dilutability desired for the resin, which is at least 1:6. After the condensation, the melamine resins are freed from excess alcohol and formaldehyde by distillation. Any residual formaldehyde present is reacted on addition of urea at temperatures from room temperature to 90° C., preferably from 60 to 70° C. Advantageously, the molar ratio of melamine to formaldehyde to ether group is from 1:1.2:1 to 1:6:6, preferably from 1:2.5:2 to 1:5:4.5.

Copolymer dispersions whose copolymers preferably comprise carboxyl, hydroxyl, amido, glycidyl, carbonyl, N-methylol, N-alkoxymethyl, amino and/or hydrazo groups are used as resin component (iii). The abovementioned functional groups in the copolymer are obtained in a conventional manner by incorporating, in the form of polymerized units, corresponding monomers which carry these functional groups. The copolymers comprise the abovementioned functional groups in general in amounts such that they may comprise, incorporated in the form of polymerized units, from 0.1 to 50% by weight, preferably from 0.3 to 20% by weight, based on the copolymer, of these monomers having functional groups.

Monomers suitable as main monomers of the comonomers having the abovementioned groups are the conventional olefinically unsaturated monomers copolymerizable therewith, for example C₁- to C₁₂-alkyl esters of acrylic acid and methacrylic acid, preferably C₁- to C₈-alkyl esters, e.g. methyl acrylate, methyl methacrylate, ethyl acrylate, ethyl methacrylate, propyl acrylate, propyl methacrylate, butyl acrylate, butyl methacrylate, 2-ethylhexyl acrylate, 2-ethylhexyl methacrylate, lauryl acrylate and lauryl methacrylate; vinyl esters of C₂- to C₄-carboxylic acids, e.g. vinyl acetate and vinyl propionate, C₁- to C₄-dialkyl esters of maleic acid and fumaric acid, vinylaromatics, such as styrene, α-methylstyrene, vinyltoluene; acrylonitrile, methacrylonitrile, acrylamide, methacrylamide and vinyl ethers having 3 to 10 carbon atoms, vinyl halides, such as vinyl chloride and vinylidene chloride; polyolefinically unsaturated compounds, such as butadiene and isoprene, and mixtures of the abovementioned monomers, provided that they are copolymerizable with one another.

For the preparation of the resin mixture, the pH of the polymer dispersion is usually adjusted to 7.5 to 10 before the addition of the other components.

The aminoplast resins thus obtained generally have solids contents of from 40 to 70% by weight. Here, the solids content is defined as the dry residue which is determined by drying with 1 g of aqueous resin for two hours in a drying oven at 120° C. The viscosity of the aqueous resins is in the range from 10 to 200 mpa.s, preferably from 30 to 150 mpa·s (20° C.).

The invention furthermore relates to aminoplast resin sheets or films comprising decorative papers which are impregnated with crosslinkable aminoplast resin and comprise from 5 to 90% by weight, based on the total fiber content, of fibers of synthetic polymers.

For the production thereof, the decorative paper described above and comprising from 5 to 90% by weight, based on the total fiber content, of fibers of synthetic polymers is impregnated with the aminoplast resins in a manner known per se.

The aminoplast resins are used in the form of a 40 to 70 percent strength by weight aqueous solution, to which a curing agent is usually added.

Suitable curing agents are, for example, Bronstedt acids, such as organic sulfonic acids and carboxylic acids, and the anhydrides thereof, e.g. maleic acid, maleic anhydride and formic acid, ammonium compounds, e.g. ammonium sulfate, ammonium sulfite, ammonium nitrate, ethanolammonium chloride and dimethylethanolammonium sulfite, and combinations of curing agents, such as morpholine/p-toluenesulfonic acid.

The curing agents can be added in amounts of from 0 to 2.5% by weight, based on the aqueous impregnating resin. A person skilled in the art knows that the dose of curing agent can be adapted to the respective requirements for the application, it being possible appropriately to adjust the reactivity of the impregnating resin/curing agent mixtures, for example via the measurement of the turbidity times and gelling times.

Assistants, such as wetting agents, may also be added to the impregnating liquors. Suitable wetting agents are, for example, ethoxylated fatty alcohols or alkylphenol ethoxylates, which can be added in amounts of from 0 to 1% by weight, based on the resin solution.

The manner in which the impregnating liquors are further processed to give melamine resin-impregnated products and the manner in which the wood-based materials are laminated with these impregnated products are known to a person skilled in the art. The decorative paper used can be processed to the same extent as for the impregnation of known commercial decorative paper with aminoplast resins.

The impregnation is effected as a rule in such a way that the decorative paper is thoroughly impregnated with the aminoplast resin solution. For example, decorative papers having a basis weight in the range from 60 to 200 g/m² are impregnated with from 120 to 150% by weight, based on the paper weight, of the impregnating liquor at room temperature. The impregnated paper is then dried to a residual moisture content of from about 5 to 10% by weight. The conventional impregnating units which introduce the desired amount of resin onto and into the papers in the one-stage or two-stage process are suitable for the impregnation. The advantage of the two-stage process is that, if appropriate, different aminoplast resins can be used for the preliminary impregnation and subsequent impregnation.

The aminoplast sheets or films produced in this manner are then shaped in the hot or cold state. Advantageously the sheets or films are pressed with the substrate at elevated temperatures of, for example, from 150 to 210° C. and/or elevated pressures of, for example, from 15 to 30 bar for a press time of, for example, from 10 to 60 s.

Advantageously, adhesion during lamination is effected by the aminoplast resin, i.e. self-adhesive aminoplast resin films are advantageously used for the 3D shaping. In some applications, however, the use of non-self-adhesive aminoplast resin sheets can also be advantageous; in this case, commercial adhesives or further adhesive carriers are used. Furthermore, subsequent adhesion may be advantageous in some applications.

The substrate, in particular wood-base material or other molded carriers, such as, for example, premolded plastics or metal sheets, and the decorative paper can, for example, be shaped together. This is advantageously effected by pressing in an in-mold press. However, a substrate having a three-dimensional structure and a decorative paper of this contour or without a contour can also be shaped in a corresponding manner. The three-dimensional shaping is advantageously effected in a membrane press or, if appropriate, in a press whose press plate corresponds to the negative shape of the three-dimensional carrier material.

For example, in such a membrane press, the upper and lower and/or lateral sides of the press mold consist of a membrane which can be subjected to pressure by air, nitrogen or liquid which, if appropriate, is heated (cf. WO 00/53667, on pages 16 to 18).

Advantageously, such a membrane press comprises a lower and an upper press table, a resilient membrane which can be pressed onto a substrate covered with aminoplast resin sheets or films and to be coated therewith and which, together with a press table, forms a pressure-tight chamber, channels for the inlet and outlet of a fluid coming into contact with the membrane, and a press control.

The term “membrane which can be pressed onto” is understood as meaning both membranes which can be lowered and membranes which can be raised or pressed on from the side.

A membrane press which has two storage containers for two differently thermostated fluids, which are provided with operating valves which can be opened and closed by the press control is advantageously used for its three-dimensional shaping. Advantageously, the membrane press has the conveying apparatus for the fluids. The membrane press preferably has separate inlets and outlets for each fluid.

Because the press preferably has two storage containers which contain differently thermostated fluids which can come into contact with the membrane alternately via operating valves and a conveying apparatus, it is possible to realize a press having a heating mixture and cooling cycle, by means of which a workpiece can first be heated and then pressed when cooled without it being necessary to transport it from one press to another press, which simultaneously has the substantial advantage that the workpiece remains fixed in the press so that the material to be laminated cannot become detached and the laminated workpiece cannot buckle or distort since it remains fixed in the membrane press until a minimum temperature is reached.

Advantageously, each storage container has a compressed-air valve and a vent valve. The content of the storage containers can be subjected to variable pressure depending on the individual process steps. Advantageously, heating apparatuses or cooling apparatuses for the fluid are arranged in the storage containers and can also be cycled in the event of increased demand for heating or heat removal during pressing.

A preferably used fluid is a liquid, such as water or thermal oil, which have a high heat capacity, so that the required quantities of heat can be supplied and removed by the fluids alone without it being necessary to heat or cool the press tables themselves. Thus, even their surfaces facing the press space can be equipped with insulation material so that no heat losses occur via the press tables. It is furthermore advantageous that the storage containers, which have compressed air and vent valves, can be subjected to pressure or reduced pressure as a function of the process steps which can be carried out using the membrane press, so that changing of the liquids can be carried out in an accelerated manner or the press pressure can be made available in an optimized manner at any desired level or on the workpieces as an aminoplast resin sheets or films.

The membrane press advantageously has, as a conveying apparatus for the liquids below the first membrane, a second resilient membrane which, via a second frame, forms a second pressure-tight chamber together with the first membrane, which chamber can be supplied with an operating fluid through inlets or outlets, depending on the individual process steps. Particularly advantageous here is the use of air as operating fluid, by means of which, when the second chamber is subjected to internal pressure, the liquid present in the first chamber between press table and membrane can be forced back into the storage container. Such a conveying apparatus for liquids has minimum technical complexity and at the same time is extremely simple and effective and requires little maintenance.

The membrane press described can furthermore advantageously be used for three-dimensional shaping if flexible aminoplast resin sheets or films (cf. DE 103 01 901) comprising absorptive cellulose-containing fibers, woven fabrics or decorative papers known from the prior art and impregnated with, for example, aminoplast resins obtained from unetherified melamine/formaldehyde condensate(s), if appropriate etherified melamine/formaldehyde condensate(s) and polymer dispersion(s), as described further above, as described, for example, in DE 200 19 180, are used.

The lamination is preferably effected over an extensive area in a single operation. Furniture parts whose mechanical stress is low are advantageously laminated with a single-ply decorative film. Particularly preferably, only a single decorative paper is used for the structure to be laminated.

Suitable substrates are particularly preferably wood-base materials, such as, for example, wood fibers or particle boards or MDF or HDF boards.

The aminoplast resin sheets or films according to the invention are distinguished in particular by the fact that surfaces which are resistant to cracking, glossy and insensitive to water vapor are obtained by pressing the aminoplast resin sheets or films onto substrates having a three-dimensionally structured surface of different materials, such as wood, plastics, fiber composites or in particular wood-base materials, e.g. plywood, wood fiber boards and in particular particle boards. Furthermore, the aminoplast resin films according to the invention are particularly suitable for completely or partly surrounding moldings. In particular, the surfaces have a very brilliant color.

Typical fields of use for the aminoplast resin sheets or films according to the invention are, as described above, furniture parts, such as, for example, kitchen fronts, panels, picture frames, door frames, doors, table tops, window sills, fronts or accessories.

### EXAMPLES

A) Production of the Decorative Paper 1

A paper was produced from a mixture of eucalyptus (20% by weight), birch (80% by weight), polyamide and polyester fibers (in each case 15% by weight, based on the pulp) in a Fourdrinier machine. Titanium dioxide (10% by weight, based on the total fibers) and silicate (5% by weight, based on the total fibers) were added to this fiber mixture. The paper had a basis weight of 131 g/m² and exhibited a Bendsten porosity of 990 ml/min.

B1) Resin System 1

Component 1: A mixture of 730 g of 40% by weight aqueous formaldehyde and 334 g of water was thermostated at 30° C. The pH of the mixture was adjusted to about 9.5 with 25% by weight of aqueous sodium hydroxide solution. 790 g of melamine were then added. The reaction mixture was then heated to 100° C., the pH decreasing slowly. Stirring was effected for about 60 min at a pH of from 8.6 to 8.8. As soon as a sample of the reaction mixture had a turbidity temperature of 50° C., the reaction mixture was cooled to room temperature.

Component 2: 8.4 g of sodium peroxodisulfate and 600 g of water were initially taken in a reaction vessel and heated to 80° C. While maintaining the temperature, feed 1 was added continuously in the course of one hour. Feed 1 was prepared from 387 g of demineralized water, 151.2 g of 2-hydroxyethyl methacrylate and 58.8 g of acrylic acid. After the beginning of feed 1, feed 2 was added in the course of a further 45 minutes. Feed 2 consisted of a solution of 81 g of demineralized water and 2.1 g of sodium peroxodisulfate. After the end of feed 1, the temperature was maintained for one hour, and feed 3 was then added at 80° C in the course of 1.5 hours and feed 4 in the course of 2 hours. Feed 3 consisted of an aqueous monomer emulsion comprising 410 g of demineralized water, 4.7 g of a 45% by weight aqueous solution of the surface-active substance corresponding to Dowfax 2A1, 378 g of styrene and 436.8 g of n-butyl acrylate. Feed 4 consisted of a solution of 410 g of demineralized water and 10.5 g of sodium peroxodisulfate. After the end of feed 4, the mixture was allowed to react for one hour at 80° C. Cooling to room temperature was then effected, 134.4 g of a 25% by weight aqueous sodium hydroxide solution were added and filtration was effected over a 200 μm sieve. The solids content of the dispersion obtained was 34.4% by weight and the pH was 7.1.

70% by weight of a solution consisting of component 1 were added to 30% by weight of a solution of component 2 while stirring. The resin mixture had a viscosity of 65 mPa.s and a solids content of 51.2% by weight.

B2) Resin System 2

A mixture of 812 g of 40% by weight aqueous formaldehyde and 358 g of water was thermostated at 30° C. The pH of the mixture was adjusted to about 9 with 25% by weight of aqueous sodium hydroxide solution. 821 g of melamine were then added. Thereafter, heating to 100° C. was effected and condensation was then carried out to a turbidity point of 50° C. After the turbidity point had been reached, the reaction mixture was immediately cooled. A pH of about 9.2 was established with 25% by weight aqueous sodium hydroxide solution. The resin solution has a viscosity of 45 mPa·s (20° C.).

C) Impregnation

Decorative paper from example 1 and standard decorative paper were impregnated with the resin mixture from example 1 and the resin from example 2, after addition of about 0.5% by weight of curing agent (e.g. curing agent 529 liquid from BASF AG), and were dried, in such a way that, when fully impregnated, the decorative papers had a solids content of from 120 to 130% and possessed a residual moisture content of from 6 to 10%.

D) 3D lamination

The melamine resin film obtained was pressed onto an MDF (medium density fiber) board having a diameter of 16.5 cm, comprising a 3D structure. 3D structures are to be understood as meaning contours having round and straight surfaces and/or edges having a defined angle. The pressing process took place in a laboratory press at from 150 to 160° C. under a force of 45 kN and in a time of 30-60 s.

E) Characterization

E1) Shapeability

The shapeability and the adhesion of the melamine resin film on the MDF board comprising a 3D structure was assessed. In the case of good shapeability, the lamination should rest completely against the structure and adhere firmly thereto without tearing, breaking or creasing.

Assessment:

0=free of tears or creases
1=free of tears, isolated creasing
2=isolated tearing, slight creasing
3=slight tearing, moderate creasing
4=moderate tearing, pronounced creasing
5=pronounced tearing, very pronounced creasing
6=broken and destroyed surface
   E2) Characterization of the Surface

The melamine resin film obtained was pressed on to a smooth MDF board at 160-165° C. under a pressure of 2.5 N/mm² and in a time of 110 s. The following tests-were carried out:

E2.1) Curing

The quality of the curing was determined by the action for 16 hours of a 0.2N hydrochloric acid which is stained with 0.004% by weight of Rhodamine B solution on the smooth laminated MDF board. In the case of good curing, the surface is not attacked by the acid. The strength of the attack can be assessed on the basis of the strength of the red coloration.

Assessment:

0=no attack
1=slight pink coloration
2=substantial red coloration
3=strong red coloration
4=strong red coloration with slight surface swelling
5=strong red coloration with strong surface swelling
6=destroyed surface
   E2.2) Cohesiveness

The cohesiveness or porosity of the laminated surface serves for assessing the sensitivity to dirt. Black shoe cream was rubbed into the surface to be tested and said surface was then cleaned again using a cloth. The shoe cream remaining in the pores permits an assessment of the cohesiveness of the surfaces.

The assessment of the surface cohesiveness is effected in the following steps:
0=pore-free
1=isolated pores
2=few pores
3=frequent pores
4=many open areas
5=very many open areas
6=no cohesivenesses

The results are presented in table 1.

TABLE 1

| | | Resin | 3D | | |
|---|---|---|---|---|---|
| Experiment | Paper | system | surface | Curing | Cohesiveness |
| 1 | Standard¹ | 2 | 5 | 0 | 0 |
| 2 | Standard¹ | 1 | 3 | 1-2 | 1-2 |
| 3 | Decorative | 2 | 1-2 | 2-3 | 2-3 |
| (according to | paper 1 | | | | |
| the invention) | | | | | |
| 4 | Decorative | 1 | 0 | 0-1 | 1 |
| (according to | paper 1 | | | | |
| the invention) | | | | | |

¹Commerical white decorative paper

1-14. (canceled)

15. A process for the production of a partly or a completely laminated substrate comprising a three-dimensionally structured surface, wherein a decorative paper which comprises from 5 to 90% by weight, based on the total fiber content, of fibers of a synthetic polymer is impregnated with a crosslinkable aminoplast resin, applied to the substrate and three-dimensionally shaped.

16. The process according to claim 15, wherein the synthetic polymer is selected from the group consisting of polyamide, polyimide, polyurethanes, polypropylene, polyethylene, polyester, polyacrylonitrile, polyvinyl alcohol and mixtures thereof.

17. The process according to claim 15, wherein the fibers of the synthetic polymer have a length of from 0.5 to 20 mm.

18. The process according to claim 15, wherein the fibers of the synthetic polymer have a diameter of from 5 to 30 μm.

19. The process according to claim 15, wherein cellulose is used as a basis of the decorative paper.

20. The process according to claim 15, wherein the decorative paper comprises from 10 to 60% by weight of fibers of synthetic polymers and from 40 to 90% by weight of cellulose.

21. The process according to claim 15, wherein the crosslinkable aminoplast resin comprises melamine/formaldehyde resin.

22. The process according to claim 15, wherein the crosslinkable aminoplast resin comprises a resin mixture comprising melamine/formaldehyde condensate, etherified melamine/formaldehyde condensate and a polymer dispersion.

23. The process according to claim 15, wherein the substrate comprises wood, particle boards or MDF or HDF boards.

24. The process according to claim 15, wherein the three-dimensionally structured surface is formed in a membrane press.

25. The process according to claim 24, wherein the membrane press comprises a lower and an upper press table, a resilient membrane which can be pressed onto the substrate covered with aminoplast resin sheets or films and to be laminated therewith and which, together with a press table, forms a pressure-tight chamber, channels for inlet and outlet of a fluid coming into contact with the membrane, and a press control.

26. An aminoplast resin sheet or film comprising decorative paper impregnated with a resin mixture comprising:
(i) from 20 to 90% by weight of one or more unetherified melamine/formaldehyde condensates,
(ii) from 0 to 80% by weight of one or more etherified melamine/formaldehyde condensates,
(iii) from 10 to 80% by weight of one or more polymer despersions, the amounts of the components (i), (ii), and (iii) summing to 100% by weight and being based on the liquid resin mixture, and comprising from 5 to 90% by weight, based on the total fiber content, of fibers of polyamide, polyimide, polyurethanes, polypropylene, polyethylene, polyester, polyacrylonitrile or polyvinyl alcohol, or mixtures thereof.

27. The aminoplast resin sheet or film according to claim 26, wherein copolymer dispersions comprising carboxyl, hydroxyl, amido, glycidyl, carbonyl, N-methylol, N-alkoxymethyl, amino and/or hydrazo groups are used as polymer dispersions.

28. A method for the lamination of substrates having three-dimensionally structured surfaces, and/or moldings comprising utilizing an aminoplast resin or film comprising a decorative paper which comprises from 5 to 90% by weight, based on the total fiber content, of fibers of synthetic polymers.
